(19) United States
(12) Patent Application Publication
(10) Pub. No.: US 2015/0052239 A1
(43) Pub. Date: Feb. 19, 2015

(54) CONTEXT BASED SPECTRUM MANAGEMENT SYSTEM

(71) Applicants: Anthony G. Lamarca, Seattle, WA (US); Vallabhajosyula S. Somayazulu, Portland, OR (US); Xue Yang, Arcadia, CA (US); Denver H. Dash, Pittsburgh, PA (US); Kerstin Johnsson, Palo Alto, CA (US); Jaideep Moses, Portland, OR (US); Wen-Ling M. Huang, Los Altos, CA (US); Omesh Tickoo, Portland, OR (US); Jeffrey R. Foerster, Portland, OR (US); Carlos Cordeiro, Portland, OR (US); Christian Maciocco, Portland, OR (US); Harry G. Skinner, Beaverton, OR (US); Geoff O. Weaver, Portland, OR (US); Xingang Guo, Portland, OR (US); Maynard C. Falconer, Portland, OR (US); Rahul C. Shah, San Francisco, CA (US); Srikathyayani Srikanteswara, Portland, OR (US)

(72) Inventors: Anthony G. Lamarca, Seattle, WA (US); Vallabhajosyula S. Somayazulu, Portland, OR (US); Xue Yang, Arcadia, CA (US); Denver H. Dash, Pittsburgh, PA (US); Kerstin Johnsson, Palo Alto, CA (US); Jaideep Moses, Portland, OR (US); Wen-Ling M. Huang, Los Altos, CA (US); Omesh Tickoo, Portland, OR (US); Jeffrey R. Foerster, Portland, OR (US); Carlos Cordeiro, Portland, OR (US); Christian Maciocco, Portland, OR (US); Harry G. Skinner, Beaverton, OR (US); Geoff O. Weaver, Portland, OR (US); Xingang Guo, Portland, OR (US); Maynard C. Falconer, Portland, OR (US); Rahul C. Shah, San Francisco, CA (US); Srikathyayani Srikanteswara, Portland, OR (US)

(21) Appl. No.: 13/969,821

(22) Filed: Aug. 19, 2013

(51) Int. Cl. H04L 12/26

(52) U.S. Cl. CPC H04L 43/0876
USPC 709/224

(57) ABSTRACT

Generally, this disclosure provides systems, devices, methods and computer readable media for context based spectrum management. A device may include a user preference determination module to determine a level-of-service preference of a user of the device, the preference associated with an application. The device may also include a user state determination module, to determine a state of the user, and a device capability determination module, to determine capabilities of the device. The device may further include an application programming interface (API) to provide the context to a cloud-based server configured to manage spectrum. The context includes the preference, the state and the capabilities. The API is further configured to receive content delivery options from the cloud-based server.

### FIELD

The present disclosure relates to spectrum management, and more particularly, to spectrum management with increased efficiency based on user, application and network contexts.

### BACKGROUND

Mobile and other wireless devices generally communicate over networks that are managed by carriers or providers and the available spectrum or bandwidth is typically constrained, (i.e., not unlimited). The quality of the experience of users of such devices may vary depending on the network bandwidth that is allocated to that user by the provider and further depending on the current usage load on the network. For example, increased data download rates, higher image resolution and/or higher audio fidelity all typically require greater bandwidth at correspondingly greater cost.

Providers generally build and maintain networks with a spectrum capacity that is based on some selected fraction of an expected peak user load in order to provide an acceptable operating margin, even though that peak load may rarely be reached. This can result in a decrease in efficiency of spectrum usage and an increase in the operating cost for the provider as well as the user.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one example embodiment consistent with the present disclosure;

FIG. 2 illustrates a block diagram of one example embodiment consistent with the present disclosure;

FIG. 3 illustrates a block diagram of another example embodiment consistent with the present disclosure;

FIG. 4 illustrates a block diagram of another example embodiment consistent with the present disclosure;

FIG. 5 illustrates a block diagram of another example embodiment consistent with the present disclosure; and

FIG. 6 illustrates a flowchart of operations of another example embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems, devices, methods and computer readable media for spectrum management with increased efficiency based on user, device, application and network contexts. A server, for example a cloud-based server, may provide application programming interfaces (APIs) to enable collection and integration of user requirements, user device characteristics, conditions of one or more networks (for example, loading), location, time and other context information to allocate spectrum bandwidth and content delivery times for applications and services to be provided to the user. By measuring (and in some embodiments, predicting) user needs, network resource constraints and application level context, network spectrum may be more efficiently utilized and the quality of the user experience may be increased. Thus, benefits are provided to the user, the network operator and the application/service providers. In some embodiments, these benefits may be made available through a fee-based subscription service.

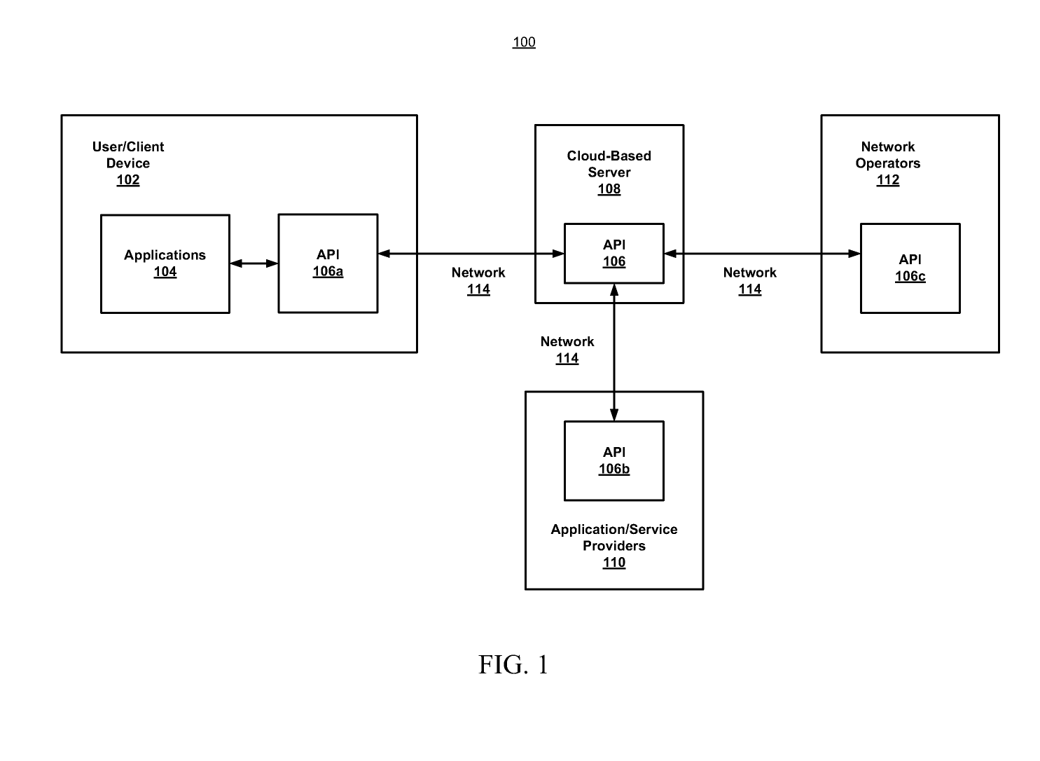

FIG. 1 illustrates a top level system diagram 100 of one example embodiment consistent with the present disclosure. System 100 is shown to include a cloud-based server 108 configured to communicate with any number of user/client devices 102 over a network 114, such as for, example a wireless or wired network. The user devices 102 may include any type of computing device such as, for example, a smart phone, laptop, smart tablet, personal digital assistant (PDA), mobile internet device (MID), convertible tablet, notebook computer, desktop computer, server, smart television, wearable device or any other suitable device capable of wireless (or wired) network connectivity, wherein the device may generally present various interfaces to a user via a display such as, for example, a touch screen, liquid crystal display (LCD), and so forth. Although a single server 108 is illustrated for simplicity, any number of servers, networks and/or applications may be deployed in various embodiments consistent with the present disclosure.

The server 108 may also communicate with application/service providers 110 such as, for example, streaming video providers, information content download services and so forth. Server 108 may further communicate with network operators 112 such as, for example, wireless carriers and telecommunications companies or other spectrum holders. Server 108 may provide an application programming interface (API) 106 configured to negotiate service parameters with other entities 102, 110, 112 over the network 114 to facilitate context-based spectrum management. The spectrum management may be directed towards improving the distribution of network load over space, time and frequency, as will be described in greater detail below. User/client device 102, application/service providers 110 and network operators 112 may also be configured to provide APIs (106a, 106b 106c) that are compatible with, or a subset of, API 106 of the cloud-based server 108, to participate in the negotiations. User/client device 102 may also include client applications configured to interact with the server applications and services provided by application/service providers 110 over network 114, some part of which may involve the participation of, or otherwise pass through cloud-based server 108.

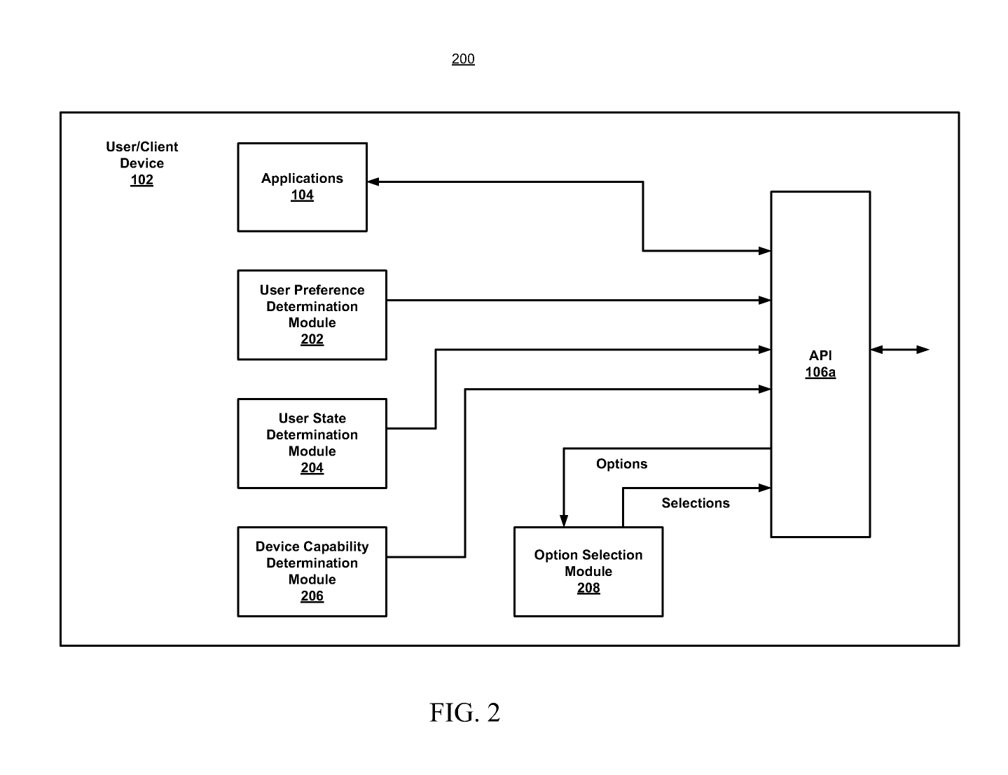

FIG. 2 illustrates a block diagram 200 of one example embodiment consistent with the present disclosure. User/client devices 102 are shown to further include user preference determination module 202, user state determination module 204, device capability determination module 206 and option selection module 208.

Preference determination module 202 may be configured to determine a level-of-service preference of a user of the device 102, where the preference may be associated with one or more of the applications 104. For example, user preferences may include a relative quality indicator associated with content to be delivered, an acceptable delay time until the delivery commences, bandwidth for the delivery, cost for the delivery and/or any other suitable characteristic. In some embodiments, the relative quality indicator may be associated with the resolution of an image or the fidelity of audio associated with downloaded content. An acceptable delay time, or time interval, may be specified by the user to indicate that content delivery may be delayed until network traffic or congestion is reduced. This may enable the user and/or the network operator to benefit from a reduction in cost associated with the delivery. Alternatively, the user may specify that content delivery is relatively urgent and should begin as soon as possible regardless of cost or at a cost that may be increased but not to exceed a specified or negotiated threshold level.

The desired delivery bandwidth may be specified to indicate the speed at which content download should occur, even if the download is delayed until a time of reduced network congestion. For example, a user may choose to schedule the download of a movie to occur relatively late at night, when network traffic is lighter, in exchange for a reduced cost. When the download begins, however, the user may nevertheless desire a relatively high bandwidth to ensure smooth play, high resolution and high fidelity for an improved viewing experience. Alternatively, the user may be watching on a small screen/lower capability device and may elect a lower bandwidth/reduced cost option.

User state determination module 204 may be configured to determine a state of the user and/or the device 102. The state may, for example, be a relatively current state and may include a location of the user and/or device, a busy/idle status of the device, a time and date, a relative urgency indicator and/or any other suitable state information that may be useful for spectrum management decisions. In some embodiments, user state may include an indication as to whether the user is moving or stationary, and if moving, a direction and speed of travel. This information may be obtained from a Global Positioning System (GPS), which may, for example, be incorporated in the device 102, or through other suitable means. Location and motion information may be related to the level of attention that the user devotes to the provided applications or services and may therefore be related to the level of quality desired for the content delivery. Measured or predicted user motion may also be used to postpone data-intensive communications until an estimated time when the user may have access to a higher bandwidth network medium.

In some embodiments, user state may include social settings, for example, whether the user is among strangers or trusted colleagues. User state may also include an indication of the degree of attention that the user is devoting to the device, which may be determined, for example, using a camera and image processing software included with the device. These, and any other detectable aspects of the user state, may affect user expectations and therefore may be further influencing factors in content delivery preference decisions.

Device capability determination module 206 may be configured to determine capabilities or characteristics of the device 102 including, for example, battery life, transmit power, receive signal strength, GPS capability, display resolution and/or other indications of content presentation capabilities.

A context may thus be generated to include the level-of-service preferences, user state, device capabilities and/or any other suitable information. The context may be provided to the cloud-based server 108 through API 106a so that the server can make context based spectrum management decisions which may include the provision of content delivery options to the device 102. The delivery options may include a relative delivery content quality indicator, a delivery delay time, a delivery bandwidth and/or a delivery cost. Delivery options may also include alternative networks such as, for example, a wired network or an unlicensed (e.g., home Wi-Fi) network, access to which may be based on the user or device location. Option selection module 208 may be configured to receive those content delivery options from the cloud-based server 108, make selections from among the options and transmit those selections back to the server 108.

In some embodiments, the API 106a may also be configured to allow the device 102 to set a Quality of Service (QoS) packet priority, for example based on context, so that network 114 may adjust the transmission priority of data packets associated with the content delivery to device 102. For example, a traffic update request from a user in motion could be given a higher priority than a similar request from a stationary user. For another example, a video streaming application could mark packets at a higher priority than packets generated by a relatively static social media application. In some embodiments, the priorities may be controlled by an operating system of the device and subsequently verified, for example during a certification process, to ensure that applications use the correct priority.

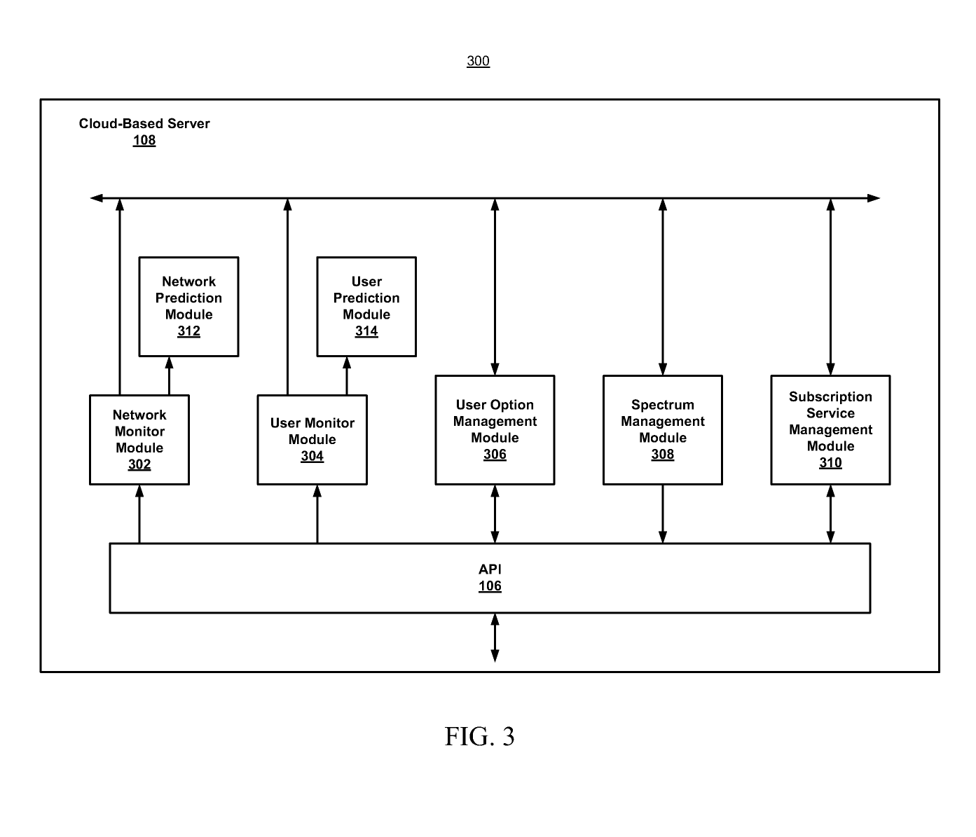

FIG. 3 illustrates a block diagram 300 of another example embodiment consistent with the present disclosure. Cloud-based server 108 is shown to further include network Monitor module 302, user monitor module 304, user option management module 306, spectrum management module 308, subscription service management module 310, network prediction module 312 and user prediction module 314.

Network Monitor module 302 may be configured to monitor availability of spectrum bandwidth in a network as well as the associated cost for content delivery at any of a number of different levels of bandwidth.

User monitor module 304 may be configured to monitor context information associated with the device 102, and/or user of the device, communicating with the network. The context may, for example, include user level-of-service preferences, user state and device capabilities as previously described.

User option management module 306 may be configured to provide content delivery options to the user of the device 102. The delivery options may be based on the context information, the available spectrum bandwidth and the associated cost of that spectrum bandwidth.

User prediction module 314 may be configured to generate an historical record of the monitored user context information and to predict a future user context and future user needs based on the historical record. Predictions may also be based on calendar data and/or collaborative filtering. Collaborative filtering, for example, involves the collection of relatively large sets of data in order to measure behaviors of many users to create suggestions, recommendations or other proactive behaviors based on those measurements. In some embodiments, these predictions may enable the retrieval and delivery of content before it is requested by the user. In some embodiments, predicted user motion may also be used to postpone data-intensive communications until an estimated time when the user may have access to a higher bandwidth network medium. For example, if the system can anticipate that a Wi-Fi hotspot will soon be available, then the downloading of a large file might be delayed if the user's context allows this.

Network prediction module 312 may be configured to predict future spectrum bandwidth availability and cost based on an aggregation of the historical records associated with the users and with the network.

Spectrum management module 308 may be configured to assign bandwidth and schedule content delivery to devices 102 based on the determined or estimated context as described above.

Subscription service management module 310 may be configured to manage a fee based subscription between the user and an enterprise associated with the server 108. The subscription enables the provision of the content delivery options to the user. In some embodiments, subscriptions and associated fees may also be negotiated between the enterprise and the network operators 112 and/or the application/service providers 110. The API 106 may be configured to facilitate these negotiations including the agreement to delay spectrum allocation to later periods of time when bandwidth is less expensive, more reliable and/or available in sufficient quantity to meet the user's or application's requirements.

In some embodiments, the monitoring of users, devices, networks, etc., by the server 108 in this system may be performed as a background process. In other words, a decision to allocate spectrum bandwidth to a user may not necessarily occur immediately, when the user runs an application on the device 102, but rather, the server may respond back to the user at a later time when suitable spectrum is available to meet the user's requirements.

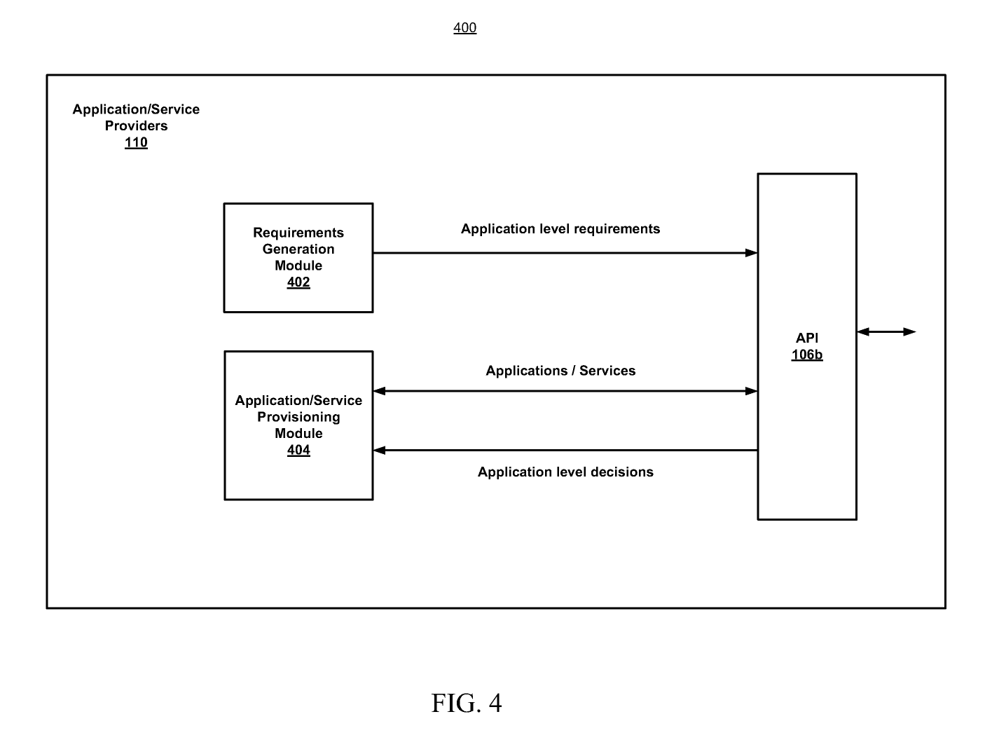

FIG. 4 illustrates a block diagram 400 of another example embodiment consistent with the present disclosure. Application/service providers 110 are shown to further include requirements generation module 402 and application/service provisioning module 404.

Requirements generation module 402 may be configured to determine or otherwise estimate the requirements of the applications or services being provided, for example, with respect to relative levels of quality and the associated bandwidth needed to achieve those levels. These application level requirements may be communicated through API 106b to the cloud-based server 108 to assist the server 108 with the performance of spectrum management operations.

Application/service provisioning module 404 may be configured to provide the applications and services to the user of the device 102 through network 114. These services may include, for example, streaming video, audio, mapping/location based services, information content downloads, and so forth. Application/service provisioning module 404 may also receive application level decisions through API 106b from cloud-based server 108. These decisions may be context based spectrum management decisions generated by the server 108 based on information and requirements provided by the user/device 102, the network operators 112 and the application level requirements generated by the requirements generation module 402.

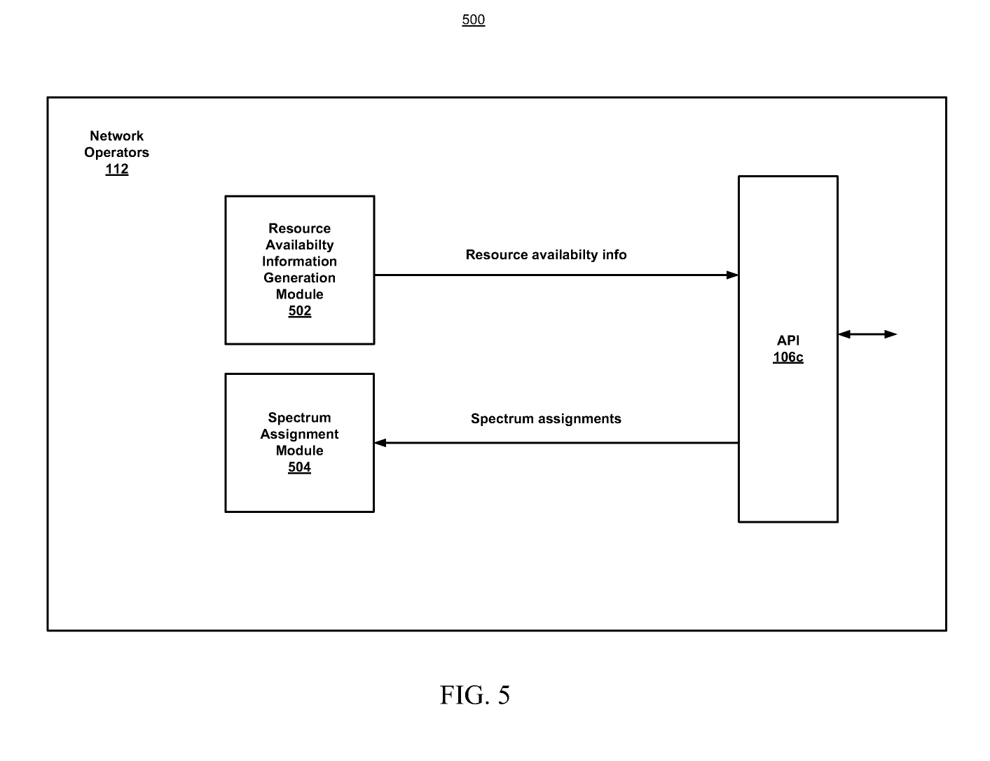

FIG. 5 illustrates a block diagram 500 of another example embodiment consistent with the present disclosure. Network operator 112 systems are shown to further include resource availability information generation module 502 and spectrum assignment module 504.

Resource availability information generation module 502 may be configured to provide spectrum management information through API 106c to the cloud-based server 108. The resource availability information may include network link quality indicators, current and/or historical network traffic load statistics, pricing information and any other suitable data related to network or spectrum management. The pricing information may depend on bandwidth, time of day or other factors and may be presented as a cost per bit or in any other useful format.

Spectrum assignment module 504 may be configured to receive spectrum assignment commands (or requests) from the cloud-based server 108 through API 106c. Spectrum assignment module 504 may then allocate spectrum bandwidth at a particular time and at a particular location to satisfy the needs of user/device 102 at an agreed upon or otherwise negotiated cost.

Any or all system components (devices 102, application/service providers 110 and network operators 112) may also be configured to provide fallback capability to legacy APIs in the event that the cloud based server 108 context based spectrum management operations are unavailable for any reason. In other words, the negotiation model provided by the APIs 106 may operate in conjunction with existing or legacy models, where the decision to allocate spectrum is made relatively instantly when the user runs an application, although the pricing may vary based on the some of the contextual parameters such as time of day and location, etc.

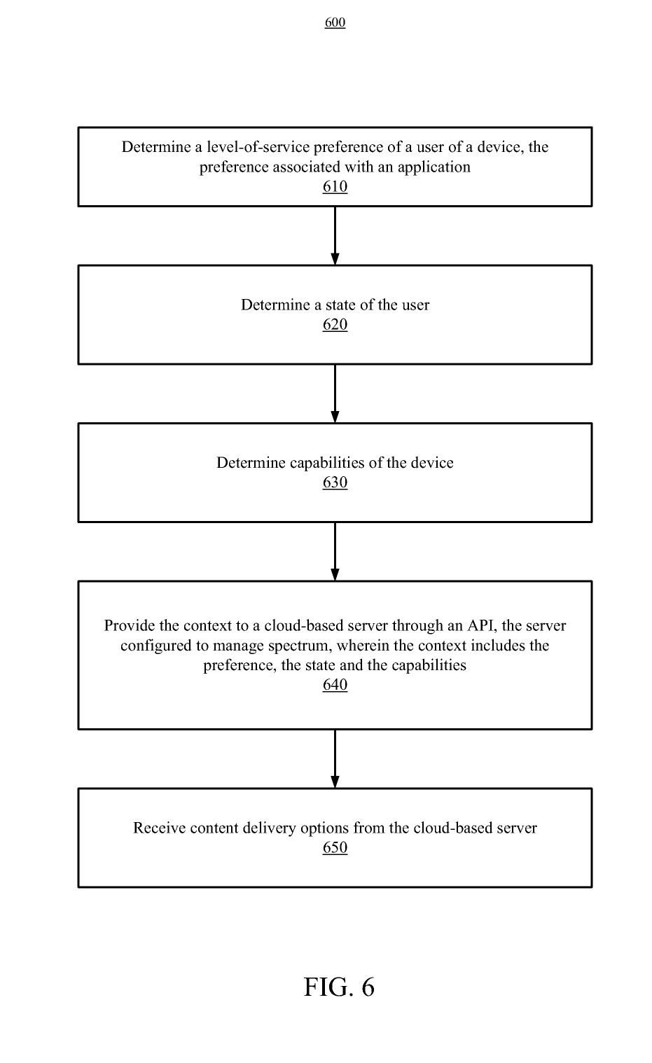

FIG. 6 illustrates a flowchart of operations 600 of another example embodiment consistent with the present disclosure. At operation 610, a level-of-service preference is determined for a user of a device. The preference is associated with an application or service provided for the user. At operation 620, a state is determined for the user. The state may include information related to location, busy-idle status, time of day or a relative urgency indicator. At operation 630, capabilities of the device are determined. The capabilities may include battery life, transmit power or receive signal strength of the device. At operation 640, a context is provided to a cloud-based server through an API. The server is configured to manage spectrum and the context includes the preference, the state and the capabilities. At operation 650, content delivery options are received from the cloud-based server.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may include, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides systems, devices, methods and computer readable media for spectrum management with increased efficiency based on user, application and network context. The following examples pertain to further embodiments.

According to one aspect there is provided a device for context based spectrum management. The device may include a user preference determination module configured to determine a level-of-service preference of a user of the device, the preference associated with an application. The device of this example may also include a user state determination module configured to determine a state of the user. The device of this example may further include a device capability determination module configured to determine capabilities of the device. The device of this example may further include an API configured to provide the context to a cloud-based server configured to manage spectrum. The context may include the preference, the state and the capabilities. The API may be further configured to receive content delivery options from the cloud-based server.

Another example device includes the forgoing components and further includes an option selection module configured to select one of the delivery options, the selection based on the context.

Another example device includes the forgoing components and the preference is a relative delivery content quality indicator, a delivery delay time, a delivery bandwidth or a delivery cost.

Another example device includes the forgoing components and the state is a location, a busy-idle status, a time of day or a relative urgency indicator.

Another example device includes the forgoing components and the capabilities are battery life of the device, transmit power of the device or receive signal strength of the device.

Another example device includes the forgoing components and the received delivery options are a relative delivery content quality indicator, a delivery delay time, a delivery bandwidth or a delivery cost.

Another example device includes the forgoing components and the API is further configured to set a QoS packet priority based on the context, the QoS packet priority associated with the content delivery.

Another example device includes the forgoing components and the device is a smartphone, a laptop computing device, a wearable device or a tablet.

According to another aspect there is provided a cloud-based server for context based spectrum management. The server may include a network monitor module configured to monitor availability of spectrum bandwidth in a network and further configured to monitor cost associated with the spectrum bandwidth. The server of this example may also include a user monitor module configured to monitor context information associated with a device and a user of the device, the device communicating with the network, and the context includes user level-of-service preferences, user state and device capabilities. The server of this example may further include a user option management module configured to provide content delivery options to the user, the delivery options based on the context information, the available spectrum bandwidth and the cost.

Another example server includes the forgoing components and the user level-of-service preference is a relative delivery content quality indicator, a delivery delay time, a delivery bandwidth or a delivery cost.

Another example server includes the forgoing components and the user state is a location, a busy-idle status, a time of day or a relative urgency indicator.

Another example server includes the forgoing components and the device capabilities are battery life of the device, transmit power of the device or receive signal strength of the device.

Another example server includes the forgoing components and further includes a user prediction module configured to generate an historical record of the monitored user context information and to predict a future user context based on the historical record.

Another example server includes the forgoing components and further includes a network prediction module configured to predict future spectrum bandwidth availability and cost based on an aggregation of the historical records associated with a plurality of the users.

Another example server includes the forgoing components and further includes a subscription service management module configured to manage a fee based subscription between the user and an enterprise associated with the server, the subscription enabling the provision of the content delivery options.

Another example server includes the forgoing components and further includes an API configured to enable exchange of the context information and the content delivery options between the server and the user.

According to another aspect there is provided a method for context based spectrum management. The method may include determining a level-of-service preference of a user of a device, the preference associated with an application. The method of this example may also include determining a state of the user. The method of this example may further include determining capabilities of the device. The method of this example may further include providing the context to a cloud-based server through an API, the server configured to manage spectrum, and the context includes the preference, the state and the capabilities. The method of this example may further include receiving content delivery options from the cloud-based server.

Another example method includes the forgoing operations and further includes selecting one of the delivery options, the selection based on the context.

Another example method includes the forgoing operations and the preference is a relative delivery content quality indicator, a delivery delay time, a delivery bandwidth or a delivery cost.

Another example method includes the forgoing operations and the state is a location, a busy-idle status, a time of day or a relative urgency indicator.

Another example method includes the forgoing operations and the capabilities are battery life of the device, transmit power of the device or receive signal strength of the device.

Another example method includes the forgoing operations and the received delivery options are a relative delivery content quality indicator, a delivery delay time, a delivery bandwidth or a delivery cost.

Another example method includes the forgoing operations and further includes setting a QoS packet priority based on the context, the QoS packet priority associated with the content delivery.

According to another aspect there is provided a system for context based spectrum management. The system may include a means for determining a level-of-service preference of a user of a device, the preference associated with an application. The system of this example may also include a means for determining a state of the user. The system of this example may further include a means for determining capabilities of the device. The system of this example may further include a means for providing the context to a cloud-based server through an API, the server configured to manage spectrum, and the context includes the preference, the state and the capabilities. The system of this example may further include a means for receiving content delivery options from the cloud-based server.

Another example system includes the forgoing components and further includes a means for selecting one of the delivery options, the selection based on the context.

Another example system includes the forgoing components and the preference is a relative delivery content quality indicator, a delivery delay time, a delivery bandwidth or a delivery cost.

Another example system includes the forgoing components and the state is a location, a busy-idle status, a time of day or a relative urgency indicator.

Another example system includes the forgoing components and the capabilities are battery life of the device, transmit power of the device or receive signal strength of the device.

Another example system includes the forgoing components and the received delivery options are a relative delivery content quality indicator, a delivery delay time, a delivery bandwidth or a delivery cost.

Another example system includes the forgoing components and further includes a means for setting a QoS packet priority based on the context, the QoS packet priority associated with the content delivery.

According to another aspect there is provided at least one computer-readable storage medium having instructions stored thereon which when executed by a processor, cause the processor to perform the operations of the method as described in any of the examples above.

According to another aspect there is provided an apparatus including means to perform a method as described in any of the examples above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A device for context based spectrum management, said device comprising:
a user preference determination module configured to determine a level-of-service preference of a user of said device, said preference associated with an application;
a user state determination module configured to determine a state of said user;
a device capability determination module configured to determine capabilities of said device; and
an application programming interface (API) configured to provide said context to a cloud-based server configured to manage spectrum, wherein said context comprises said preference, said state and said capabilities, said API further configured to receive content delivery options from said cloud-based server.

2. The device of claim 1, further comprising an option selection module configured to select one of said delivery options, said selection based on said context.

3. The device of claim 1, wherein said preference is a relative delivery content quality indicator, a delivery delay time, a delivery bandwidth or a delivery cost.

4. The device of claim 1, wherein said state is a location, a busy-idle status, a time of day or a relative urgency indicator.

5. The device of claim 1, wherein said capabilities are battery life of said device, transmit power of said device or receive signal strength of said device.

6. The device of claim 1, wherein said received delivery options are a relative delivery content quality indicator, a delivery delay time, a delivery bandwidth or a delivery cost.

7. The device of claim 1, wherein said API is further configured to set a Quality-of-Service (QoS) packet priority based on said context, said QoS packet priority associated with said content delivery.

8. The device of claim 1, wherein said device is a smartphone, a laptop computing device, a wearable device or a tablet.

9. A cloud-based server for context based spectrum management, said server comprising:
a network monitor module configured to monitor availability of spectrum bandwidth in a network and further configured to monitor cost associated with said spectrum bandwidth;
a user monitor module configured to monitor context information associated with a device and a user of said device, said device communicating with said network, wherein said context comprises user level-of-service preferences, user state and device capabilities; and
a user option management module configured to provide content delivery options to said user, said delivery options based on said context information, said available spectrum bandwidth and said cost.

10. The server of claim 9, wherein said user level-of-service preference is a relative delivery content quality indicator, a delivery delay time, a delivery bandwidth or a delivery cost.

11. The server of claim 9, wherein said user state is a location, a busy-idle status, a time of day or a relative urgency indicator.

12. The server of claim 9, wherein said device capabilities are battery life of said device, transmit power of said device or receive signal strength of said device.

13. The server of claim 9, further comprising a user prediction module configured to generate an historical record of said monitored user context information and to predict a future user context based on said historical record.

14. The server of claim 13, further comprising a network prediction module configured to predict future spectrum bandwidth availability and cost based on an aggregation of said historical records associated with a plurality of said users.

15. The server of claim 9, further comprising a subscription service management module configured to manage a fee based subscription between said user and an enterprise associated with said server, said subscription enabling the provision of said content delivery options.

16. The server of claim 9, further comprising an application programming interface (API) configured to enable exchange of said context information and said content delivery options between said server and said user.

17. A computer-readable storage medium having instructions stored thereon which when executed by a processor result in the following operations for context based spectrum management, said operations comprising:
determining a level-of-service preference of a user of a device, said preference associated with an application;
determining a state of said user;
determining capabilities of said device;
providing said context to a cloud-based server through an application programming interface (API), said server configured to manage spectrum, wherein said context comprises said preference, said state and said capabilities; and
receiving content delivery options from said cloud-based server.

18. The computer-readable storage medium of claim 17, further comprising the operations of selecting one of said delivery options, said selection based on said context.

19. The computer-readable storage medium of claim 17, wherein said preference is a relative delivery content quality indicator, a delivery delay time, a delivery bandwidth or a delivery cost.

20. The computer-readable storage medium of claim 17, wherein said state is a location, a busy-idle status, a time of day or a relative urgency indicator.

21. The computer-readable storage medium of claim 17, wherein said capabilities are battery life of said device, transmit power of said device or receive signal strength of said device.

22. The computer-readable storage medium of claim 17, wherein said received delivery options are a relative delivery content quality indicator, a delivery delay time, a delivery bandwidth or a delivery cost.

23. The computer-readable storage medium of claim 17, further comprising the operations of setting a Quality-of-Service (QoS) packet priority based on said context, said QoS packet priority associated with said content delivery.
